(19) United States
(12) Patent Application Publication
(10) Pub. No.: US 2006/0171726 A1
(43) Pub. Date: Aug. 3, 2006

(54) Copying machine, device and process for use in copying machine for notifying original left behind

(75) Inventors: Tatsuo Noda, Osaka-shi (JP); Yasushi Saito, Osaka-shi (JP)

Correspondence Address: SMITH, GAMBRELL & RUSSELL, LLP, 1850 M STREET, N.W., SUITE 800, WASHINGTON, DC, 20036, US

(73) Assignee: KYOCERA MITA CORPORATION

(21) Appl. No.: 11/313,734

(22) Filed: Dec. 22, 2005

(30) Foreign Application Priority Data
Jan. 31, 2005 (JP) 2005-23629

(51) Int. Cl. G03G 15/00

(52) U.S. Cl. 399/16

(57) ABSTRACT

A copying machine disclosed in the present invention comprises: a discharge tray for receiving a discharged sheet; a platen cover that is manually opened and closed; an opened/closed state detecting sensor for detecting whether the platen cover is in an opened or closed state; a discharged sheet detection sensor for detecting whether a discharged sheet is present or absent on the discharge tray; and an LED for notifying a user after completion of a copying operation that an original is left behind upon detection of the discharged sheet being removed from the discharge tray while the platen cover is not opened.

### BACKGROUND OF THE INVENTION

1. Field of the invention

The present invention relates to a copying machine.

2. Description of Related Art

There are times when users of copying machines leave originals behind after they finish copying. To cope with this, a copying machine has been proposed in Japanese Unexamined Patent Publication No. 1993-27463, in which an alarm sound such as a buzzer or the like is set off when the original cover is not opened within a predetermined period of time after finishing of a copying operation.

In the proposed copying machine, the original cover is automatically opened and an alarm sound is set off when a predetermined period of time elapses after completion of a copying operation. For this reason, the original cover abruptly opens and the alarm starts sounding even when the user, for example, is preparing for a subsequent copying operation without forgetting to unload the original, which surprises the user, resulting in poor operability. In addition, when the above-mentioned predetermined period of time is long, the user may have left from the copying machine after finishing the copying operation, which means it is impossible to notify that the original is left behind.

### SUMMARY OF THE INVENTION

The present invention has been achieved in view of the circumstances described above. An object of the present invention is to provide a copying machine capable of reliably notifying the user of an original being left behind. Another object of the present invention is to provide a device and a process for use in a copying machine for reliably notifying the user of the original being left behind.

A copying machine according to the present invention which determines that an original is left behind and notifies the user thereof even after a sheet with a copied image thereon is taken out of a discharge tray as long as a platen cover (original cover) is not opened.

The notification is preferably effected by a display. When a copying operation is finished, users tend to leave the original behind while they pick up the copied sheets to carry them off. Therefore, the present invention is preferably arranged such that the display notifies the user of the original being left behind. In other words, the present invention makes it possible to reliably notify the user of the original being left behind after copying.

### BRIEF DESCRIPTION OF THE DRAWINGS

FIG. 1 is a front view showing an external appearance of a copying machine.

FIG. 2 is a plan view showing an external appearance of the copying machine.

FIG. 3 is a block diagram of an electrical arrangement of the copying machine.

FIG. 4 is a flowchart illustrating a series of operations of the copying machine.

### DETAILED DESCRIPTION OF PREFERRED EMBODIMENTS

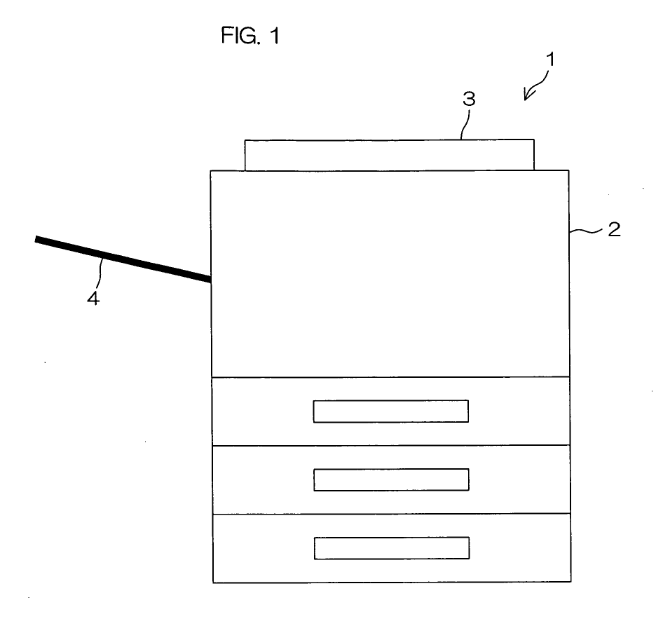

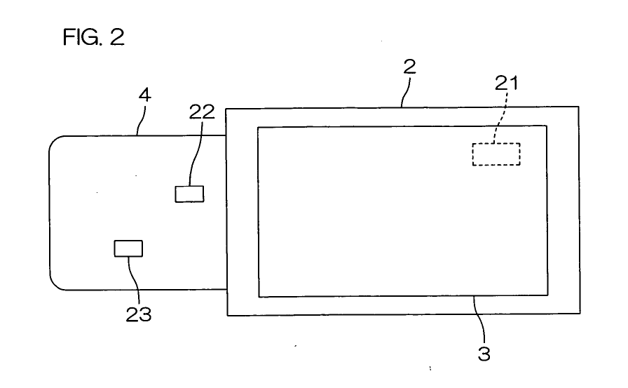

FIGS. 1 and 2 show external views of an embodiment of a copying machine according to the present invention, in which FIG. 1 is a front view, and FIG. 2 is a plan view thereof.

A platen cover (original cover) 3 that is manually opened and closed is provided on the upper side of a main body 2 of a copying machine 1. A discharge tray 4 for receiving discharged sheets that are discharged with a copied image thereon is provided on the left side of the main body 2. While the discharged sheets are discharged onto the discharge tray 4 protruding laterally from the main body 2 in this embodiment, the discharge tray 4 may be provided in a so-called body-inside paper discharge space formed in the main body 2. That is, the main body 2 may be constructed such that it comprises upper and lower parts separated by a space and a discharge tray is provided on an upper surface of the lower part.

An opened/closed state detecting sensor 21 for detecting whether the platen cover 3 is in an opened state or closed state is provided in an upper part of the main body 2. A discharged sheet detecting sensor 22 for detecting whether a discharged sheet is present or absent on the discharge tray 4 is disposed on the discharge tray 4. An LED 23 for notifying the user of the original being left behind is disposed on the discharge tray 4.

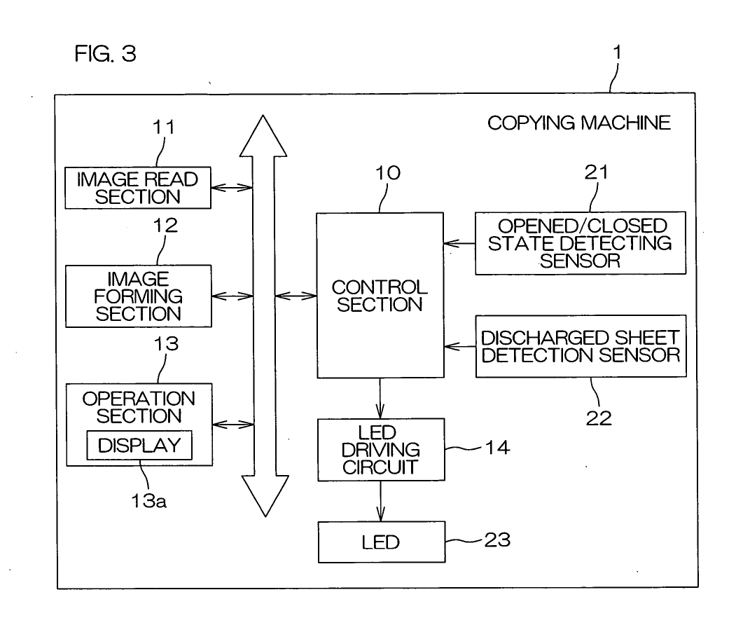

FIG. 3 shows an electrical arrangement of the copying machine 1.

The copying machine 1 comprises an image reading section 11, image forming section 12, an operation section 13 and a control section 10 for controlling these sections. The operation section 13 includes a display 13a provided with a touch panel for displaying various setting screens. The control section 10 includes a CPU, a ROM for storing the programs thereof, and a RAM for storing necessary data. In addition, an opened/closed state detecting sensor 21, a discharged sheet detecting sensor 22 and an LED driving circuit 14 are connected to the control section 10. An LED 23 is connected to the LED driving circuit 14.

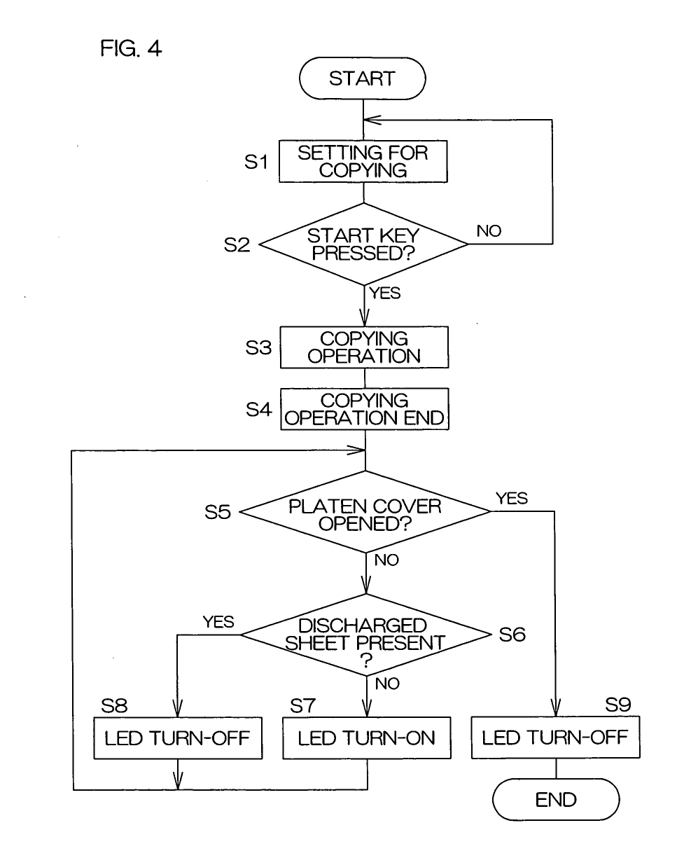

FIG. 4 illustrates a series of operations of the copying machine 1 controlled by the control section 10.

A user opens the platen cover 3 to set an original on a contact glass (not diagramed) on the main body 2, and then closes the platen cover 3.

Thereafter, settings for copying are made (Step S1) and a start key is pressed by the user (Step S2), by which a copying operation is started (Step S3).

After finishing the copying operation (Step S4), whether the platen cover 3 is opened or not is determined based upon a signal detected by the opened-closed state detecting sensor 21 (Step S5).

When it is determined that the platen cover 3 is not opened, the original is determined as remaining on the main body 2. Also, it is determined whether a discharged sheet is present on a discharge tray 4 or not based upon a signal detected by a discharged sheet detecting sensor 22 (Step S6).

When it is determined that no discharged sheet is present on the discharge tray 4, the LED 23 for notifying presence of an original left behind is turned on (Step S7). Meanwhile, once the LED 23 is turned on in Step S7, it is kept in the turned-on state until it is turned off in Step S8 or Step S9 described later, or until the power of the copying machine 1 is turned off.

In cases where a discharged sheet is present on the discharge tray 4 in Step S6 above, the LED 23 is turned off when it is in a turned-on state (Step S8). When the LED 23 is in a turned-off state, the state remains. After Step S8, the process returns to Step S5. Incidentally, the case where the LED 23 is in a turned-on state while it is determined that a discharged sheet is present on the discharge tray 4 in Step S6 above refers to a case for copying a plurality of sheets where, after the LED 23 is once turned on in Step S7 as a result of removal of a discharged sheet from the discharge tray 4, another discharged sheet is transferred onto the discharge tray 4.

When it is determined that the platen cover 3 is opened in Step S5 above, the original is determined as not remaining on the main body 2, and the LED 23 is turned off when it is in a turned-on state (Step S9). The process in this case is then terminated.

In the foregoing embodiment, after a copying operation is finished, the LED 23 is turned on when the platen cover 3 is not opened and no discharged sheets are present on the discharge tray 4. That is, after a copying operation is finished, when discharged sheets on the discharge tray 4 are removed by the user with the original cover 3 being closed, the LED 23 is turned on. As a result, the user can be reliably notified that the original is left behind by the turning-on of the LED 23. Moreover, since the LED 23 is disposed on the discharge tray 4 and turned on when the user removes the discharged sheets on the discharge tray 4, the user can easily recognize the turning-on of the LED 23, which is another advantage of this embodiment.

Meanwhile, although the LED 23 is not necessarily disposed on the discharge tray 4, it is preferably disposed in a vicinity of the discharge tray 4. In addition, a buzzer may be used instead or together with the LED 23.

When a buzzer is adopted, turning on/off of the buzzer may be controlled in the same manner as the LED 23, or it may be controlled such that the buzzer is turned on only for a certain period in Step S7 above. In this case, the buzzer does not need to be turned off in Step S8 or Step S9.

What is claimed is:

1. A copying machine comprising:
a discharge tray for receiving a discharged sheet that is discharged after an image is copied thereon;
a platen cover that is manually opened and closed;
an opened/closed state detecting sensor for detecting whether the platen cover is in an opened or closed state;
a discharged sheet detecting sensor for detecting whether a discharged sheet is present or absent on the discharge tray; and
notification means for notifying a user after finishing a copying operation that an original is left behind upon receipt of a signal from the opened/closed state detecting sensor indicating the platen cover is not opened and a signal from the discharged sheet detection sensor indicating a discharge sheet is removed from the discharge tray.

2. The copying machine according to claim 1, wherein the notification means comprises a display.

3. The copying machine according to claim 1, wherein the notification means comprises a display disposed in a vicinity of the discharge tray.

4. The copying machine according to claim 3, wherein the display includes an LED disposed on the discharge tray.

5. The copying machine according to claim 1, wherein the notification means comprises a buzzer.

6. A device for use in a copying machine for notifying a user of an original being left behind comprising:
a discharge tray on which a copied sheet with a copied image thereon is discharged;
a display disposed in association with the discharge tray that is visually recognizable by the user upon removal of the copied sheet from the discharge tray; and
control means for turning on the display after completion of a copying operation when the copied sheet is removed from the discharge tray while a platen cover that is manually opened and closed remains closed.

7. The device for notifying a user of an original being left behind according to claim 6, wherein the display includes an LED, the LED being disposed on an upper surface of the discharge tray.

8. A process for notifying a user of an original being left behind for use in a copying machine comprising:
a cover opening state detection step for detecting that an original cover is opened after completion of a copying operation;
a copied sheet removal (pick-up)★ detection step for detecting that a copied sheet discharged on a discharge tray is removed after completion of the copying operation; and
a step for turning on an LED disposed in association with the discharge tray when the cover opening state detection is not performed before the copied sheet removal (pick-up) detection.
